(19) United States
(12) Patent Application Publication
(10) Pub. No.: US 2001/0039201 A1
(43) Pub. Date: Nov. 8, 2001

(54) FISHBACK ASSEMBLY FOR A CROP SEPARATION DEVICE

(76) Inventor: FRITZ KARL LAUER, KRAHENBERG (DE)

Correspondence Address: KEVIN J MORIARTY, PATENT DEPARTMENT, DEERE & COMPANY, JOHN DEERE ROAD, MOLINE, IL, 612658098

(21) Appl. No.: 09/286,360

(22) Filed: Apr. 5, 1999

(30) Foreign Application Priority Data
Apr. 8, 1998 (DE) 198 15 730.4

(51) Int. Cl. A01F 12/30; B02B 3/08

(52) U.S. Cl. 460/113

(57) ABSTRACT

A fishback assembly which is mounted on top of a separation device on an agricultural combine. The fishback assembly comprises a series of vertical fishback flanges that are coupled to one another by upstream and downstream mounting brackets. The mounting bracket is mounted to the separation device by mounting bolts passing through mounting holes formed ion the mounting brackets.

### BACKGROUND OF THE INVENTION

1. Field of the Invention

The invention is directed to a fishback assembly for use on a separation device.

2. Description of the Prior Art

DE-B-1,957,843 discloses a straw walker for threshers and combines, which comprises a rectangular frame and several oscillating trays. The oscillating trays have a perforated cover on their conveyance surface located on the top. The cover is held between two vertical walls having saw toothed edges. The design of these oscillating trays is such that their conveyance surface slopes upwards in the downstream direction.

DE-B-1,161,073 pertains to a combine with straw walkers, onto which oscillating trays are placed which can be tilted vertically. In this manner, the conveyance surface can be placed in positions with different rising slopes, and thus the separation behavior can be modified.

According to DE-A1-2,943,042, a straw walker of a combine for harvesting corn cobs is equipped with a cantilevered fishback, which extend, as cantilevered saw tooth metal sheets, over a subsequent downstream walker. That portion of the straw walker over which the fishbacks are positioned is open. Those portions of the straw walkers not having fishbacks positioned over them are provided with an apertured straw walker grid cover. These fishbacks and open straw walkers are now used for the corn. In harvesting cereal grains the fishbacks are removed and the walker is closed.

Finally, the brochure “D 7000 HYDROSTATIC of Dronningborg, print code DM1059 GB 1079 3.000” shows a combine with straw walkers, over whose lengths several walker trays with different rising slopes are provided with apertured grid covers. Fishbacks formed from saw tooth metal sheet parts are placed in the middle and in the direction of conveyance onto the grid covers, which parts are to achieve an additional loosening of the material.

### SUMMARY

It is an object of the present invention to provide a fishback assembly of simple construction that can be easily manufactured.

The present invention provides a fishback assembly that promotes the separation of small grains, such as cereal grain, from a crop material mat. The fishback assembly is easily mounted to a separation device, since several fishback flanges are connected to each other to form one fishback assembly. Although the present invention could be mounted to a variety of separation devices, such as, straw walkers, grain pans and/or sieves, it is particularly well suited for attachment to a straw walker and more specifically an apertured grid cover covering the straw walker trough.

The fishback assembly comprises a number of fishback flanges and mounting brackets holding the fishback flanges together as a unit. The top edge of the fishback flanges is provided with a saw toothed edge. The mounting bracket has an L-shaped cross section with one of the legs of the L being provided with mounting apertures through which the mounting bolts pass. The mounting apertures are arranged to correspond to the mounting apertures used in securing straw walker grid covers to the top of a straw walker trough to simplify the mounting process.

The use at the terminal end of two mounting brackets results in a higher rigidity of the fishback assembly, and it also constitutes less of an impediment to the separation process. The fishback assembly is mounted to a separation device by mounting bolts passing through holes located in the mounting brackets, thereby providing a user-friendly operation.

If the mounting brackets, like the fishback flanges, are designed in the same manner, high fabrication numbers can be achieved, which reduces the part costs. If the mounting brackets are mounted on the top and the bottom, the rigidity of the fishback flanges is increased.

The mounting brackets are rigid as they have an L-shaped cross section similar to angle iron. Enlarging the connection surface between the fishback flanges and the mounting brackets prevents material fatigue in the connection area. Because the second arm is designed with larger dimensions only in the connection area, sufficient room remains in the remaining area to allow the flow of material to pass.

The saw tooth design of the upper edge of the fishback flanges ensures a good conveyance effect of the fishback assembly and pulls apart the crop material mat in a second direction resulting in the release of grain and chaff from the crop material mat.

Since the separation behavior of the fishback assembly depends essentially on the characteristics of the crop material mat fishback flanges having different configurations, such as, rising or falling top edges offer the possibility to adapt the separation behavior to specific crop material mat characteristics.

A separation device equipped with the fishback assemblys is particularly well suited to use with a straw walker separation device. More specifically, the fishback assembly keeps the crop material mat elevated away from the grid cover covers so that the grid cover apertures do not become clogged. The action of the straw walkers on the fishback assemblies shake the crop material mat in such a manner that grain and chaff fall out of the crop material mat and are further separated by the apertured grid covers.

In particular, for a subsequent assembly and disassembly, it is very useful if mounting apertures of the fishback assembly correspond to the mounting apertures of the apertured grid covers. Thus, no additional measures are required, such as welding, drilling holes, or similar procedures. Rather, mounting bolts of the corresponding apertured grid covers are loosened, the fishback assembly is placed on top, and both elements are attached with the already existing mounting bolts.

Because of the high separation capacity required in today's combines, it is of great advantage in increasing the performance if they are equipped with fishback assemblies on the straw walkers and/or the grain pan and/or the sieves.

### BRIEF DESCRIPTION OF THE DRAWINGS

FIG. 1 is a semi-schematic side view of a combine.

FIG. 2 is a side view of a separation device having a fishback assembly of the present invention.

FIG. 3 is a perspective view of the fishback assembly.

### DETAILED DESCRIPTION

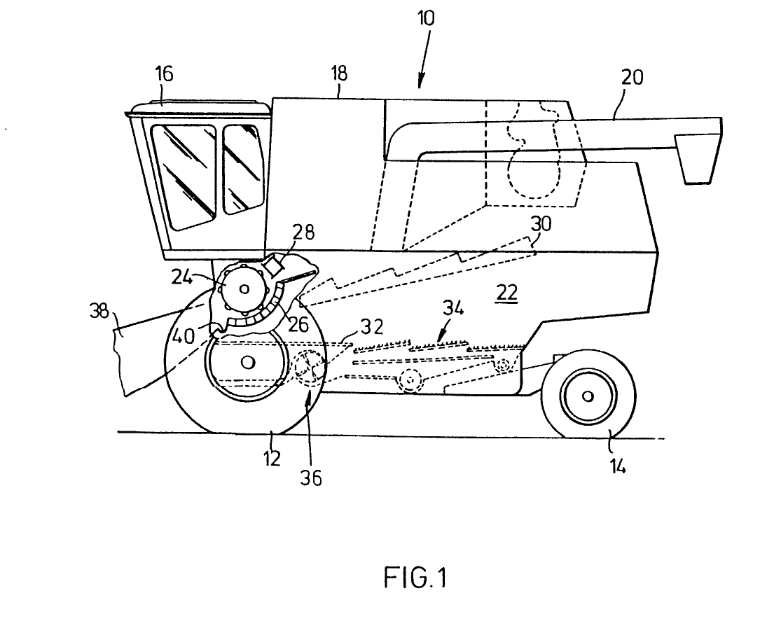

A combine 10, shown in FIG. 1, is supported on wheels 12 and 14. The front wheels 12 are driven and the back wheels 14 can be steered. The combine 10 is provided with an operator's cab 16 from which it is operated. Instead of a combine the invention could also be used on a stationary thresher, an experimental threshing installation or similar installations. A grain tank 18 is located behind operator's cab 16. Grain temporarily stored in grain tank 18 is discharged therefrom by discharge auger 20. The grain tank 18 is located on a frame 22. Crop material entering the combine 10 is threshed by a threshing cylinder 24, associated concave 26, and beater 28. The threshing system divides the crop into larger and smaller components. A significant portion of the smaller components pass through the concave 26 and onto grain pan 32. The larger components including some smaller components trapped in the mat of threshed crop material is transferred to straw walkers 30. The straw walkers loosen the threshed crop mat releasing the smaller components. The released smaller components are directed to the grain pan 32. After the threshed crop mat passes over the straw walkers 30 this material is expelled out the rear of the combine 10. The smaller components located on the grain pan include grain and chaff. The grain pan 32 directs the smaller components received from the concave 26 and the straw walkers 30 to sieves 34. Air blown through the sieves 34 by blower 36 blows the chaff out the rear of the combine and allows grain to fall to the floor of the combine where it is collected by a transverse auger which directs the grain to a clean grain elevator. The clean grain elevator lifts the cleaned grain to grain tank 18. Standing and down crops are collected and gathered by a harvesting assembly, not shown, which directs the harvested crop material to feederhouse 38. The feederhouse 38 encloses a slat type conveyor that directs the harvested crop material past stone trap 40 to the threshing assembly.

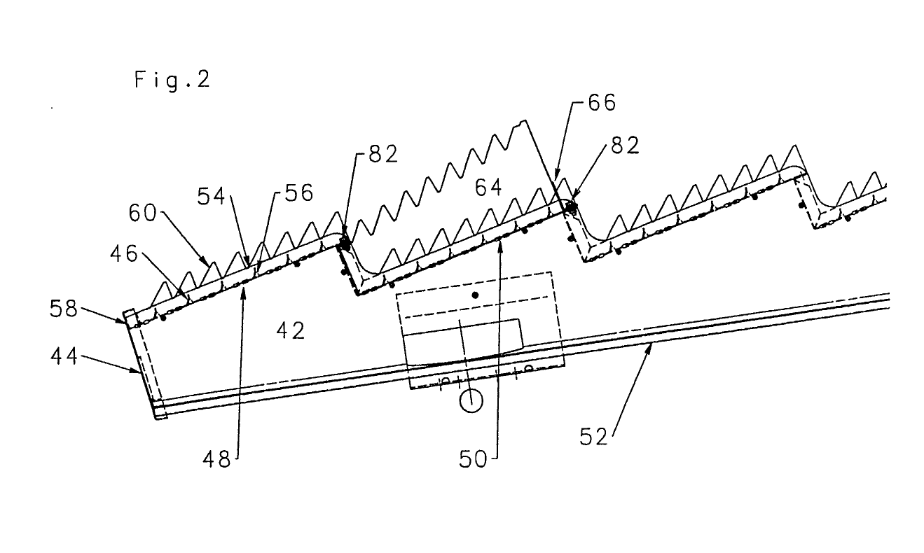

FIG. 2 shows the upstream end of the straw walker 30 having lateral walls 42, a front wall 44, apertured grid cover 46, and a first and a second step, 48 and 50. A third step which is not designated in more detail, is only indicated.

The straw walker 30 is designed in the form of a trough which in principle opens towards the top, which is enclosed laterally by the side walls 42, at the front end by the front wall 44 and optionally at the bottom with a floor 52. In the example shown, the lateral walls 42 is equipped in its upper area with a saw tooth shaped rising and falling edge 54. The lateral walls 42, the front wall 44 and the floor 52 are, in the conventional manner, made of steel sheet metal as a single unit, which is either bent out of a metal sheet or assembled by welding. The straw walker 30 is located on crankshafts, not shown, and it is moved by these in an oscillating manner, that is up and down, as well as back and forth.

The front wall 44 connects the lateral walls 42 and the floor 52 and it forms an assembly which constitutes a rigid connection.

The apertured grid cover 46 is equipped with a multitude of openings 56, which are formed by fishplate or punched parts, and which allow the passage of grain and chaff. The apertured grid cover 46 runs parallel to the edge 54 and is screwed onto laterally extending mounting flanges 58. The mounting flanges are rigidly connected with the lateral walls 42. A multitude of different grid covers 46 with different openings 56 for different crops maybe provided. In this manner it would be easy to change grid covers for different crops.

While the separated material is loosened and further separated on the grid covers 46, the crop material mat, from which the separated material originates, is applied to the saw tooth parts 60 of the edge 54 of lateral walls 42. Based on the direction of the saw tooth parts 60, the crop material mat is reliably entrained downstream, that is from left to right in the drawing.

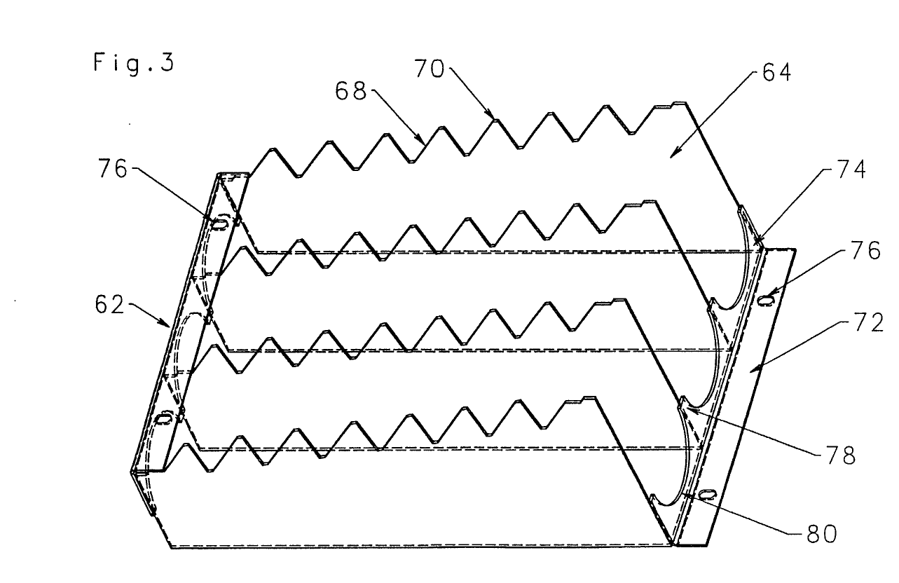

FIG. 3 is a fishback assembly 62 according to the invention, comprising four fishback flanges 64 and fore and aft mounting brackets 66. The fishback assembly 62 is designed as a welded unit and it can be applied to the mounting flanges 58 with or without a grid cover. The area of the separation device 30 starting from and including step 50 is particularly well suited for using the present fishback assembly 62.

The fishback flanges 64 are parallel and run longitudinally with respect to the flow of the crop material mat. The fishback flanges 64 are identical, a situation which may be advantageous for reasons pertaining to fabrication technology, but it is not absolutely required. Depending on the width of the straw walker 30 or their apertured grid cover 46, one or more fishback flanges 64 can be provided. A side view of the fishback flanges 64 shows they have an irregular trapezoidal shape. As the fishback flanges proceed from upstream to downstream as dictated from the flow of crop material they increase in height. The upper edge 68 of the fishback flanges 64 has a saw tooth shape. The position and form of the resulting saw tooth part 70 is selected in such a manner that its rising flank is located upstream, and it is followed by a strongly down sloping, almost vertical flank downstream.

The mounting brackets 66 are designed as angle profiles and they contain a first leg 72 and a second leg 74. The first leg 72 is essentially horizontal or in the direction of conveyance, and it contains one or more attachment apertures 76, which are used for accommodating mounting bolts 82 shown in FIG. 2. In this way the fishback assembly 62 is screwed onto the mounting flanges 58. However, it is also conceivable to use other attachment assemblies 76, 82, for example, brackets, hooks, spring clips, latches, clasps, and other mechanical couplers.

The second leg 74 is essentially at a right angle with respect to the first leg 72. The second leg 74 has tall segments 78 and short segments 80. The tall segments 78 are where the second leg contacts the fishback flanges, and the small segments 80 are located between the tall segments 78. For reasons pertaining to fabrication and rigidity, the transition between the segments 78 and 80 forms a regular curve.

FIG. 3 shows that the mounting bracket 66 located on the upstream side of the fishback assembly 62. This upstream mounting bracket 66 is mounted by its first arm 72 to the top of the edge 68 of the fishback flanges 64. Its second arm 74 extends downward from the first arm 72. In contrast, the first arm 74 the mounting bracket 66 located on the downstream side of the fishback assembly 62 extends downstream from the fishback flanges 64. The second arm 74 is connected to the downstream edges of the fishback flanges 64.

The connection of the fishback flanges 64 to the mounting brackets 66 advantageously takes place by welding. The fishback flanges 64, in the assembled state, are parallel, although it seems also possible to use, for example, a diverging arrangement. FIG. 3 shows that the welded construction of the fishback assembly 62 results in a construction which is intrinsically rigid.

FIG. 2 shows what position the fishback assembly 62 assumes in the assembled condition, and how it is attached to the straw walker 30. The fishback assembly 62 covers the same area as the apertured grid cover 46 located on the second step 50. For the attachment of both, mounting bolts 82 are used, which are inserted through the mounting openings 76 and corresponding mounting openings located in the mounting flanges 58 and in the grid covers 46. It can clearly be seen that, the edge 68 represents more or less a continuation of the edge 54, although it is slightly steeper in progression than the edge 54.

Finally, it is apparent, that in the area of the fishback assembly 62, the crop material mat lies only on the top edges 68 of the fishback flanges 64 and that the grain and chaff separated from the crop material mat can fall through the clearance between the fishback flanges 64 onto the apertured grid cover 46, where it is further separated. Furthermore, it can be seen that the fishback assembly 62 can be assembled and disassembled in the simplest manner, without damaging the straw walker 30.

The invention should not be limited by the above described embodiment, but should be limited solely by the claims that follow.

1. A fishback assembly for mounting to a separation device, the fishback assembly comprising:
at least two longitudinally extending fishback flanges having a top edge which engages a crop material mat to be conveyed; and
a laterally extending mounting bracket is mounted to the fishback flanges and is provided with a mounting assembly for securing the fishback assembly to an separation device.

2. A fishback assembly as defined by claim 1 wherein the fishback flanges are parallel to one another.

3. A fishback assembly as defined by claim 2 wherein the fishback assembly has an upstream side and a downstream side and the mounting bracket is mounted to the upstream side of the fishback assembly thereby forming an upstream mounting bracket.

4. A fishback assembly as defined by claim 3 wherein the downstream side of the fishback assembly is provided with a downstream laterally extending mounting bracket having a mounting assembly for securing the fishback assembly to a separation device.

5. A fishback assembly as defined by claim 4 wherein the fishback assembly has a top side and a bottom side, wherein one of the upstream mounting bracket and the downstream mounting bracket is mounted to the top side of the fishback assembly and the other of the upstream mounting bracket and the downstream mounting bracket is mounted to the bottom side of the fishback assembly.

6. A fishback assembly as defined by claim 5 wherein the upstream mounting bracket is mounted to the top side of the fishback assembly and the downstream mounting bracket is mounted to the bottom side of the fishback assembly.

7. A fishback assembly as defined by claim 6 wherein the upstream mounting bracket and the downstream mounting bracket have an L-shaped cross section defined by a first leg and a second leg.

8. A fishback assembly as defined by claim 7 wherein the first arm of both the upstream mounting bracket and the downstream mounting bracket are provided with mounting assemblies for securing the fishback assembly to a separation device

9. A fishback assembly as defined by claim 8 wherein the second arm of both the upstream mounting bracket and the downstream mounting bracket have tall segments adjoining to the fishback flanges and short segments locate between the tall segments.

10. A fishback assembly as defined by claim 9 wherein the top edge of the fishback flanges has a saw toothed configuration.

11. A fishback assembly as defined by claim 10 wherein the height of the fishback flanges increases as the fishback flange proceeds from the upstream end to the downstream end.

12. A straw walker comprising:
an open trough having lateral sides, a closed bottom and an open top, the trough also having laterally extending mounting flanges;
an apertured grid cover closing at least a portion of the open top of the trough, the apertured grid cover having a mounting assembly for mounting the apertured grid to the laterally extending mounting flanges; and
a fishback assembly having a plurality of longitudinally extending fishback flanges that are mounted to a laterally extending mounting bracket having mounting assemblies that correspond to mounting assemblies on the apertured grid cover.

13. A straw walker as defined by claim 12 wherein the fishback assembly covers the apertured grid cover and is placed on the laterally extending flanges by the same mounting assemblies.

14. A straw walker as defined by claim 13 wherein the fishback flanges are parallel to one another and have top edges that have a saw toothed configuration.

15. A straw walker as defined by claim 14 wherein the fishback assembly has an upstream side and a downstream side and the mounting bracket is mounted to the upstream side of the fishback assembly thereby forming an upstream mounting bracket.

16. A straw walker as defined by claim 15 wherein the downstream side of the fishback assembly is provided with a downstream laterally extending mounting bracket having a mounting assembly for securing the fishback assembly to a separation device.

17. A straw walker as defined by claim 16 wherein the fishback assembly has a top side and a bottom side, wherein the upstream mounting bracket is mounted to the top side of the fishback assembly and the downstream mounting bracket is mounted to the bottom side of the fishback assembly.

18. A straw walker as defined by claim 17 wherein the upstream mounting bracket and the downstream mounting bracket have an L-shaped cross section defined by a first leg and a second leg.

19. A straw walker as defined by claim 18 wherein the first arm of both the upstream mounting bracket and the downstream mounting bracket are provided with the mounting assemblies for securing the fishback assembly to the apertured grid cover.

20. A straw walker as defined by claim 19 wherein the mounting assemblies on the both the upstream mounting bracket and the downstream mounting bracket includes mounting holes that correspond to mounting holes located in the apertured grid cover.
